(19) United States
(12) Patent Application Publication
(10) Pub. No.: US 2014/0369834 A1
(43) Pub. Date: Dec. 18, 2014

(54) Method And System For Harvesting Drag Force Acting On Moving Vehicles

(71) Applicant: Basel Alsayyed, Al-Ain (AE)

(72) Inventor: Basel Alsayyed, Al-Ain (AE)

(21) Appl. No.: 13/919,894

(22) Filed: Jun. 17, 2013

(51) Int. Cl. F03D 9/00

(52) U.S. Cl. CPC F03D 9/002
USPC 416/1; 416/55

(57) ABSTRACT

There is provided a system for harvesting drag force acting on a moving vehicle, the system comprising a fan comprising blades and a fan rotating shaft, the fan being configured to be mounted on the moving vehicle for receiving air flow resulting from the drag force acting on the moving vehicle such that the air flow act on the blades during movement of the vehicle impelling rotation of the blades, and wherein the fan rotating shaft is adapted to be connected to and in movement cooperation with the blades for rotating by the effect of the rotation of the blades for converting the air flow into kinetic energy. There is further provided a method of harvesting drag force acting on a moving vehicle, the system comprising converting air flow resulting from the drag force acting on a moving vehicle into kinetic energy, and converting the kinetic energy into at least one of mechanical energy and electrical energy for operating mechanical and electrical components of the vehicle respectively.

### FIELD OF INVENTION

This invention relates to the field of reducing the negative effects of drag force acting on moving vehicles, and more particularly to a method and system for harvesting drag force acting on moving vehicles and converting the drag force into kinetic and electrical energy.

### BACKGROUND OF THE INVENTION

Fuel consumption is one of the most important challenges for automotive, aeronautic and other industries in the field of transport. Drag force acting on moving vehicles due to air/wind resistance collaborates substantially on increasing fuel consumption required for such moving vehicles. More than 30% of the fuel moving vehicles use is consumed to overcome the drag force acting against the moving direction of such vehicles. Drag force increases as the speed of the moving vehicle increases. For example, by increasing the speed from 55 MPH to 70 MPH, fuel consumption increases about 20% due to the increase of the drag force acting against the moving vehicle.

The different conventional approaches to deal with this challenge were essentially concentrated on reducing weight, improving combustion efficiency and improving aerodynamics design and redesign of the external bodies of such vehicles for reducing the effect of the drag force on moving vehicles and therefore on fuel consumption. So much optimization has been done along those lines, to the limit that not much progress has been achieved in the past decade. Traditional approaches attempted to reduce the drag force and ignored taking advantage of the drag force acting on moving vehicles.

### SUMMARY OF THE INVENTION

It is therefore an object of the present invention to provide a method and a system for harvesting and converting drag force acting on moving vehicles into kinetic and electric energy that overcome the above mentioned drawbacks.

The present invention utilizes the impact of the drag force on moving vehicles instead of reducing it. A method and system are provided for capturing the drag force and converting it into a rotational motion (kinetic energy) and subsequently into mechanical and/or electrical energy. Energy harvested out of the rotational force is used to generate electric power for operating electrical components of the vehicle or as a kinetic energy to act on certain mechanical components of the vehicle to help push the vehicle forward.

Two main forms of energy have been tested: electric power and kinetic energy. A generator has been attached to the prototype vehicle to generate electric power. And a mechanism to transfer the rotational force of the captured drag force to the wheels of the moving vehicle.

The system captures the drag force and change its direction is adapted to be mounted on moving vehicles. Example is the trucks were there is a huge frontal area that results in substantial drag force. The trucks could utilize the generated power to cool the trucks which transport foods and frozen materials. Another example is the buses and even trains where the generated power could be used as a source to power the accessories within the public transportation. Also, for Sport Utility Vehicles (SUVs), vans and small passenger cars, power could be used for powering the accessories as well transferring the rotational power to the wheels to help move the vehicle at the desired speed with less fuel.

As a first aspect of the invention, there is provided a system for harvesting drag force acting on a moving vehicle, the system comprising a fan comprising blades and a fan rotating shaft, the fan being configured to be mounted on the moving vehicle for receiving air flow resulting from the drag force acting on the moving vehicle such that the air flow act on the blades during movement of the vehicle impelling rotation of the blades, and wherein the fan rotating shaft is adapted to be connected to and in movement cooperation with the blades for rotating by the effect of the rotation of the blades for converting the air flow into kinetic energy.

Preferably, the system further comprises an electric generator for generating electricity comprising a generator rotating shaft, where the generator rotating shaft is adapted to be connected to and in movement cooperation with the first rotating shaft for rotating by the effect of the rotation of the first rotating shaft, such that the rotation of the generator rotating shaft enables the electric generator to transform the kinetic energy into electrical energy.

Preferably, the system further comprises a first pulley having a first radius connected to the fan rotating shaft and a second pulley having a second radius connected to the generator rotating shaft for enabling the movement cooperation between the fan rotating shaft and the generator rotating shaft, the first and second pulleys being in movement cooperation via a cable acting between them.

Preferably, the first radius is larger than the second radius for increasing the rotation frequency of the generator rotating shaft.

Preferably, the system further comprises a battery for storing the generated electrical energy.

Preferably, the vehicle has electricity operable components and the generator is connected to the electricity operable components for transmitting electricity for operation.

The vehicle can be a truck and the electricity operable components can comprise a freezer and a refrigerator. As explained below, the vehicle can also be a train, an aircraft, a car, a motorcycle or any other form of vehicle which can produce an drag force during movement.

The vehicle can also be a hybrid vehicle and the electricity operable components can comprise a vehicle's battery in this case.

The moving vehicle has mechanical movement components using a mechanical force for moving the vehicle in a movement direction. Preferably, the fan rotating shaft is adapted to be connected to and be in movement cooperation with the mechanical movement components for converting the kinetic energy into mechanical energy providing an additional mechanical force to the movement components of the vehicle.

The mechanical movement components can comprise wheel axial shafts connected to drive wheels. In this case, the fan rotating shaft is adapted to be connected to and in movement cooperation with the axial shafts and the drive wheels.

The system preferably further comprises a third pulley having a third radius connected to the fan rotating shaft and a fourth pulley having a fourth radius connected to the wheel axial shafts for enabling the movement cooperation between the fan rotating shaft and the wheel axial shafts, the third and fourth pulleys being in movement cooperation via a cable acting between them.

Preferably, the third radius is smaller than the fourth radius for increasing the torque of the drive wheels.

Preferably, the system further comprises a wind collector adapted to be mounted on the front side of the vehicle for maximizing collection of the air flow acting on the moving vehicle.

The wind collector can be in the form of a funnel, or any other form to maximize capture of the air flow. The funnel is preferably made of a light and resistant material.

Preferably, the first rotating shaft is cylindrical and the blades extend circumferentially from the first rotating shaft.

Preferably, the shaft is in the form of a hollow cylindrical tube for minimizing weight of the shaft.

As another aspect of the invention, there is provided a method of harvesting drag force acting on a moving vehicle, the method comprising:
converting air flow resulting from the drag force acting on a moving vehicle into kinetic energy; and
converting the kinetic energy into at least one of mechanical energy and electrical energy for operating mechanical and electrical components of the vehicle respectively.

Preferably, the method further comprises orienting the air flow acting on the front side of the moving vehicle inside the vehicle for conversion into at least one of mechanical and electrical energy.

The mechanical components can comprise wheels drive and the electrical components can comprise at least one of a radio, battery, freezer, refrigerator and lights.

Further advantages of the invention will become apparent from the drawings and the following description.

### BRIEF DESCRIPTION OF THE DRAWINGS

The invention will now be described by way of example only, with reference to the accompanying drawings, in which:

FIG. 1 is a bloc diagram showing a system 26 for harvesting drag force of a moving vehicle in accordance with one embodiment of the present invention;

FIG. 2 is schematic showing a wind collector and a fan in accordance with one embodiment of the present invention;

FIG. 3 is a photograph of a prototype showing a fan with a rotating shaft and pulleys in accordance with one embodiment of the present invention; and

FIG. 4 is a flow chart illustrating a method in accordance with one embodiment of the present invention.

### DETAILED DESCRIPTION OF THE INVENTION

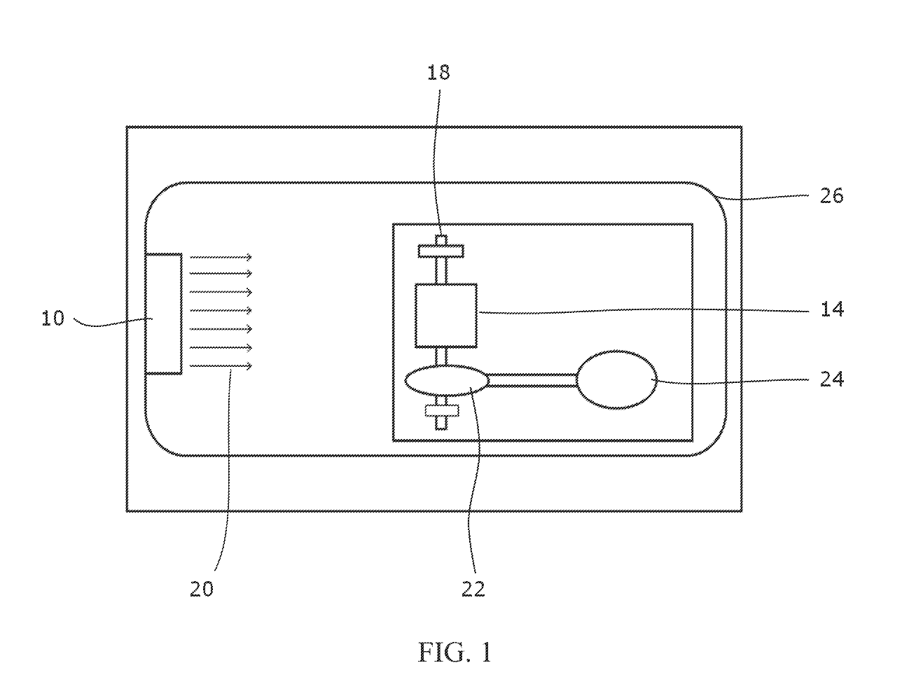

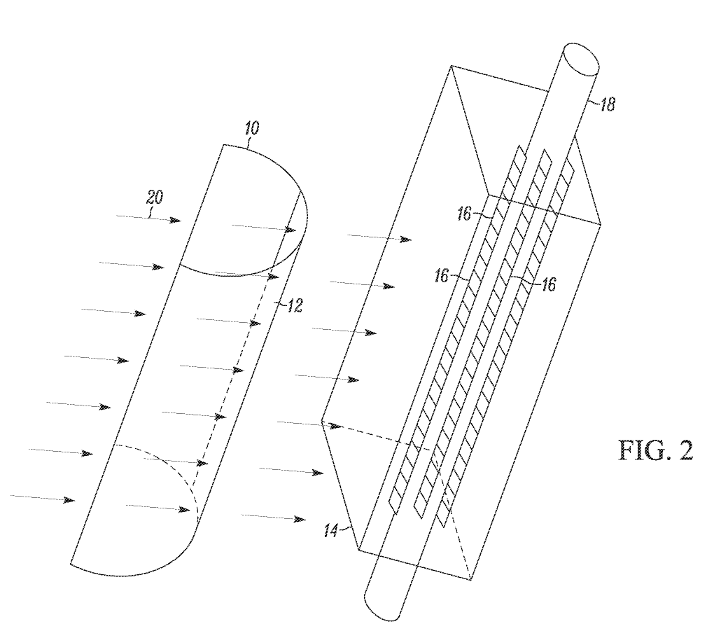

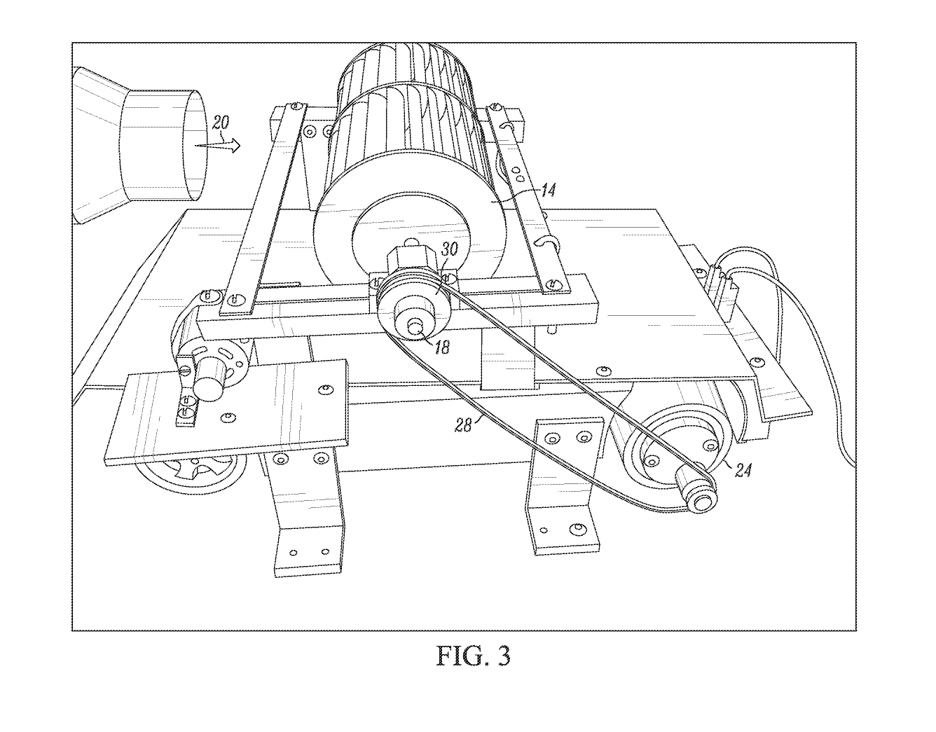

Referring to FIGS. 1 to 3, there is provided a system 26 for harvesting and converting drag force acting on moving vehicles into kinetic energy. The system 26 comprises a wind collector 10, a fan 14, and a generator 22.

The wind collector 10 is adapted to be mounted to the moving vehicle for capturing and orienting the air flow 20 to the fan 14. The wind collector 10 can be of the form of a funnel or any other form suitable for the specific type of vehicle on which is mounted. The role of the wind collector 10 is to maximize capture of the wind acting on the vehicle during movement. The quantity of wind acting on a moving vehicle is directly proportional to the speed of the vehicle. The wind collector 10 is preferably made of a light and resistant material. The objective is to minimize the weight of the wind collector 10 all in maximizing its resistance to the wind force acting on the moving vehicle for avoiding rupture. A suitable material can for example be reinforced plastic, such as PVC.

The fan 14, on its basic form, comprises blades 16 and a fan rotating shaft 18 and acts in the same manner as a wind turbine and/or windmill. The wind collector 10 collects the air flow 20 acting on the moving vehicle and orients the air flow 20 towards the fan 14. The blades 16 of the fan 14 are adapted to rotate by the effect of the air flow 20 acting on them resulting in the rotation of the hub. The blades 16 preferably extend radially from the rotating shaft 18. The fan rotating shaft 18 has a rotation axis preferably extending perpendicular to the direction of the air flow 20 acting on the blades 16. It should be understood by a person skilled in the art that the fan rotating shaft 18 can be directly or indirectly in movement cooperation with the blades 16. In other terms, the blades 16 can extend directly from the fan rotating shaft 18, or alternatively, the blades 16 can extend from a hub which is connected to the fan rotating shaft 18. The configuration of the fan 14 is flexible based on the vehicle and the specific type of application.

In one application, the fan rotating shaft 18 is adapted to be connected to an electric generator 22 for converting the kinetic energy resulting from the rotation of the fan rotating shaft 18 into electric energy. The electric energy can be stored in a battery, or alternatively used immediately to operate vehicle's electric/electronic accessories such as the heating system, air condition, internal refrigerator/freezer, radio and other accessories located within the vehicle and operable by means of electricity. In case of a hybrid vehicle, the converted electric energy can also be used to charge the battery.

In another application, the fan rotating shaft 18 is adapted to be connected to mechanical components of the vehicle which require mechanical energy to operate, such as transmissions and the wheels in order to convert the wind energy into mechanical energy for operation of these components.

These two applications can be implemented simultaneously or in the alternative. Accordingly, the system 26 can be used for converting wind energy into electric energy for operating electric components of the vehicle and, simultaneously or alternatively, for converting wind energy into mechanical energy for operating mechanical components of the vehicle.

The fan rotating shaft 18 can be connected to the electric generator 22 in different manners, for example through a gear mechanism or a pulley system 30. The objective is to have the fan rotating shaft 18 in movement cooperation with the generator rotating shaft such that when the fan rotating shaft 18 rotates by the effect of the air flow 20 acting on the blades 16, the generator rotating shaft rotates in consequence for converting the kinetic energy into electrical energy.

In one embodiment, the fan rotating shaft 18 is connected to a first pulley 30 configured to rotate along with the rotating shaft 18 and the generator rotating shaft is connected to a second pulley configured to rotate along with the generator shaft. A cable 28 extends between the first pulley 30 and the second pulley for enabling movement cooperation between the first 30 and second pulleys and consequently between the fan rotating shaft 18 and the generator rotating shaft for enabling the generator rotating shaft to rotate when the fan rotating shaft 18 is in rotation.

The first pulley (at the fan side) 30 has a first radius and the second pulley (at the generator side) has a second radius. Preferably, the first radius is bigger than the second radius in order to increase the rotation frequency (RPM) of the generator rotating shaft. In fact, the higher the RPM of the generator shaft is, the better it is for generating electricity. Therefore, the ratio between the first and second radius should be maximized in order to maximize the RPM of the generator rotating shaft for enhancing electricity generation.

In another embodiment, the fan rotating shaft 18 is connected to a third pulley configured to rotate along with the fan rotating shaft 18 and the wheels rotating axils are connected to a fourth pulley configured to rotate along with the wheels rotating axils. A cable extends between the third pulley and the fourth pulley for enabling movement cooperation between the third and fourth pulleys and consequently between the fan rotating shaft 18 and the wheels rotating axils for providing mechanical energy to the wheels 24 bringing an additional force to these along the direction of the vehicle when the fan rotating shaft 18 is in rotation.

The third pulley (at the fan side) has a third radius and the fourth pulley (at the wheels side) has a fourth radius. Preferably, the third radius is smaller than the fourth radius in order to increase the torque of rotating the wheels 24. In fact, the bigger the torque is, the better it is for rotating the wheels 24. Therefore, the ratio between the third and fourth radius should be minimized in order to maximize the torque of the rotating wheels 24.

The vehicle can be any type of moving vehicle such as a car, a train, an aircraft, a motorcycle, a boat, etc.

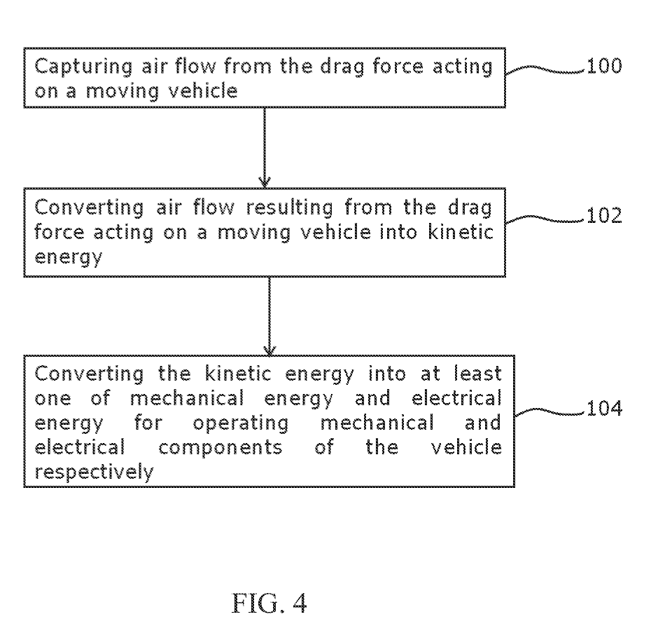

Referring to FIG. 4, there is provided a method harvesting drag force acting on a moving vehicle, the system 26 comprising capturing and orienting the air flow 20 acting on the front side of the moving vehicle inside the vehicle 100, converting air flow 20 resulting from the drag force acting on a moving vehicle into kinetic energy 102, and converting the kinetic energy into at least one of mechanical energy and electrical energy for operating mechanical and electrical components of the vehicle respectively 104.

Although, the figures, rates, flows, dimensions and other numbers presented herein above and/or in the drawings have been used to prove the concept of the invention, they apply for the experimental set-up only and should not be construed for limiting the scope of the invention. They can be scaled up for commercial scale processing without departing from the scope of the present invention.

Although the above description contains many specificities, these should not be construed as limitations on the scope of the invention but is merely representative of the presently preferred embodiments of this invention. The embodiment(s) of the invention described above is (are) intended to be exemplary only. The scope of the invention is therefore intended to be limited solely by the scope of the appended claims.

1. A system for harvesting drag force acting on a moving vehicle, the system comprising:
a fan comprising blades and a fan rotating shaft, the fan being configured to be mounted on the moving vehicle for receiving air flow resulting from the drag force acting on the moving vehicle such that the air flow act on the blades during movement of the vehicle impelling rotation of the blades, and wherein the fan rotating shaft is adapted to be connected to and in movement cooperation with the blades for rotating by the effect of the rotation of the blades for converting the air flow into kinetic energy.

2. The system as claimed in claim 1, further comprising an electric generator for generating electricity comprising a generator rotating shaft, where the generator rotating shaft is adapted to be connected to and in movement cooperation with the first rotating shaft for rotating by the effect of the rotation of the first rotating shaft, such that the rotation of the generator rotating shaft enables the electric generator to transform the kinetic energy into electrical energy.

3. The system as claimed in claim 2, further comprising a first pulley having a first radius connected to the fan rotating shaft and a second pulley having a second radius connected to the generator rotating shaft for enabling the movement cooperation between the fan rotating shaft and the generator rotating shaft, the first and second pulleys being in movement cooperation via a belt acting between them.

4. The system as claimed in claim 3, wherein the first radius is larger than the second radius for increasing the rotation frequency of the generator rotating shaft.

5. The system as claimed in claim 4, further comprising a battery for storing the generated electrical energy.

6. The system as claimed in claim 4, wherein the vehicle has electricity operable components and wherein the generator is connected to the electricity operable components for transmitting electricity for operation.

7. The system as claimed in claim 6, wherein said vehicle is a truck and said electricity operable components comprise a freezer and a refrigerator.

8. The system as claimed in claim 6, wherein said vehicle is a hybrid vehicle and said electricity operable components comprise a vehicle's battery.

9. The system as claimed in claim 1, wherein the moving vehicle has mechanical movement components using a mechanical force for moving the vehicle in a movement direction, wherein the fan rotating shaft is adapted to be connected to and be in a movement cooperation with the mechanical movement components for converting the kinetic energy into mechanical energy providing an additional mechanical force to the movement components of the vehicle.

10. The system as claimed in claim 9, wherein the mechanical movement components comprise wheel axial shafts connected to drive wheels, wherein the fan rotating shaft is adapted to be connected to and in movement cooperation with the axial shafts and the drive wheels.

11. The system as claimed in claim 10, further comprising a third pulley having a third radius connected to the fan rotating shaft and a fourth pulley having a fourth radius connected to the wheel axial shafts for enabling the movement cooperation between the fan rotating shaft and the wheel axial shafts, the third and fourth pulleys being in movement cooperation via a belt acting between them.

12. The system as claimed in claim 11, wherein the third radius is smaller than the fourth radius for increasing the torque of the drive wheels.

13. The system as claimed in claim 1 further comprising a wind collector adapted to be mounted on the front side of the vehicle for maximizing collection of the air flow acting on the moving vehicle.

14. The system as claimed in claim 13, wherein said wind collector is in the form of a funnel.

15. The system as claimed in claim 14, wherein said funnel is made of a light and resistant material.

16. The system as claimed in claim 13, wherein the first rotating shaft is cylindrical and the blades extend circumferentially from the first rotating shaft.

17. The system as claimed in claim 16, wherein the shaft is in the form of a hollow cylindrical tube for minimizing weight of the shaft.

18. A method of harvesting drag force acting on a moving vehicle, the system comprising:
converting air flow resulting from the drag force acting on a moving vehicle into kinetic energy;
converting the kinetic energy into at least one of mechanical energy and electrical energy for operating mechanical and electrical components of the vehicle respectively.

19. The method as claimed in claim 18, further comprising:
capturing and orienting the air flow acting on the front side of the moving vehicle inside the vehicle for conversion into at least one of mechanical and electrical energy.

20. The method as claimed in claim 19, wherein the mechanical components comprise wheels drive and the electrical components comprise at least one of a radio, battery, freezer, refrigerator and lights.
